(19) United States
(12) Patent Application Publication
(10) Pub. No.: US 2006/0125837 A1
(43) Pub. Date: Jun. 15, 2006

(54) System for stream video process

(75) Inventors: Hung Chun Chiu, HsinTien (TW); David Lee, HsinTien (TW)

Correspondence Address: BRUCE H. TROXELL;SUITE 1404, 5205 LEESBURG PIKE, FALLS CHURCH, VA, 22041, US

(73) Assignee: REALLUSION INC.

(21) Appl. No.: 11/299,842

(22) Filed: Dec. 13, 2005

(30) Foreign Application Priority Data
Dec. 14, 2004 (TW) 093138663

(51) Int. Cl. G09G 5/00

(52) U.S. Cl. 345/582

(57) ABSTRACT

A system and method for processing animation stream are disclosed. Sequential images are input to the system and transformed to an animation. The system comprises a sequential image input module for inputting sequential images in real time, an feature based image process module changing the input sequential images, a feature process module varying parameters of the feature based image process module according to time variable, and a sequential image output module outputting the varied sequential images.

### BACKGROUND OF THE INVENTION

1. Field of the Invention

The invention is related to a system and method processing and adjusting image stream in real time and creating an animation.

2. Description of the Related Art

Typically, an animation stream is created by the following methods:

(1). Hand drafting by an artist based on real photos. In this case, the artist simplifies outline of photo image and exaggerates the facial features. As done manually, those who draw the image must be very skillful, and it takes a long time.

(2). Created quickly by a software capable of producing a funny character. It is, however, limited to types and functions of the software, a specific effect of character is not easily created, such as a real time image stream.

(3). Created by a filter functions of a special image processing software. For example, the filter functions in Adobe PhotoShop is employed to twist a face image to produce certain funny effects. In such case, only the outline of the image can be changed. Stroke effect, however, cannot be generated in this way. Such complex image processing software must be operated manually by a skillful professional, and every photo has to be processed individually and step by step, moreover, thereby a real time animation stream cannot be produced.

(4). U.S. patent application Ser. No. 10/692,818 “Image Adjusting System and Method” discloses an image processing method, wherein a sequential image is processed to generate animation. However, in this Application, each image needs to be detected and twisted and cannot be processed continuously. Therefore, the efficiency of performance is poor, the requirements cannot be satisfied in a real time case and the quality of continuity of images is also bad. Although, some prior arts disclose system and method of creating animation for real time image stream, but such methods only process the entire image rather than specific portion of the image, such as background, and the capability of audio-video synchronization thereof is limited.

### SUMMARY OF THE INVENTION

This invention provides a system and a method for processing real time animation stream. Sequential images are input to the system and transformed to a real time animation. The system comprises a sequential image input module for inputting sequential images in real time, an feature based image process module for changing the input sequential images, a feature process module for varying parameters of the feature based image process module according to time variable, and a sequential image output module outputting the varied sequential images.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram of the system of the invention.

FIG. 2 is a block diagram of an embodiment of the invention.

FIG. 3 is a block diagram of another embodiment of the invention.

FIGS. 4A to 4F are schematic views of an embodiment of the invention.

FIGS. 5A to 5C are schematic views of another embodiment of the invention.

FIGS. 6A to 6B are schematic views of another embodiment of the invention.

FIGS. 7A to 7C are schematic views of another embodiment of the invention.

FIGS. 8A to 8C are schematic views of another embodiment of the invention.

FIGS. 9A to 9B are schematic views of another embodiment of the invention; and

FIG. 10 is a flow chart of the method of the invention.

### DETAILED DESCRIPTION OF THE INVENTION

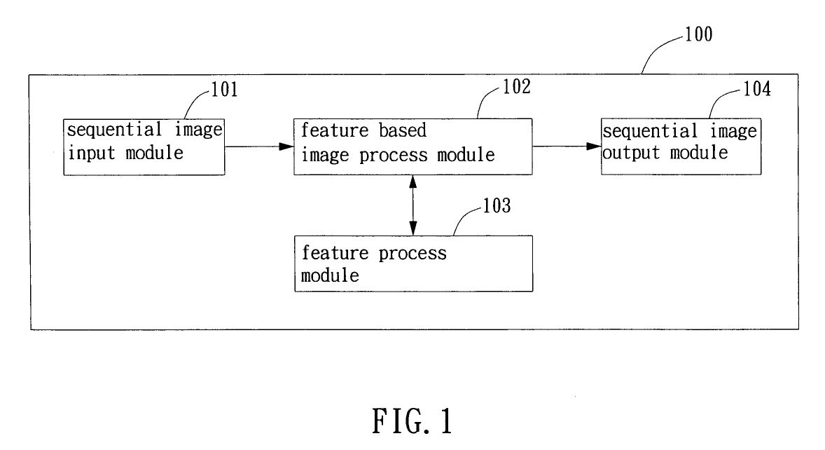

Please referring to FIG. 1 first, FIG. 1 is a main block diagram of the system of the present invention. As seen, a system 100 for processing streaming video according to the present invention comprises a sequential image input module 101, a feature based image process module 102, a feature process module 103 and a sequential image output module 104.

The sequential image input module 101 inputs sequential images in real time which can be sequential image captured by a video camera or a web camera, or available image files stored previously. The feature based image process module 102 changes the input sequential images. The feature process module 103 varies parameters of the feature based image process module according to the time variable. The sequential image output module 104 output sequential images. An animation is created in real time from some real time input sequential images via the described modules.

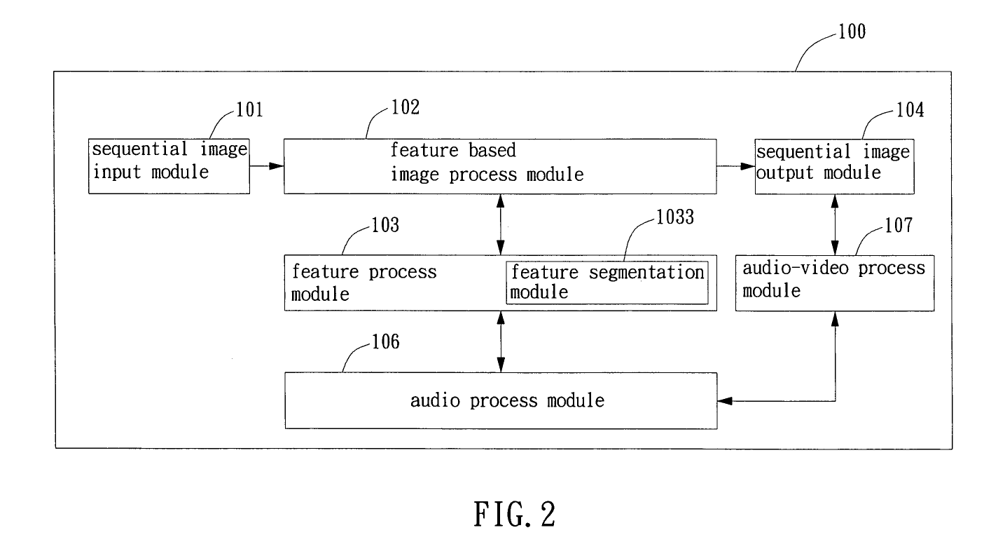

Next, referring to FIG. 2, another embodiment of the invention is shown. The system 100 further comprises an audio process module 106, an audio-video process module 107 and an feature segmentation module 1033 in the feature process module 103. The feature segmentation module 1033 divides characteristic objects or characteristic regions of the input sequential images and processing the characteristic objects or regions to create animation in real time. The audio process module 106 processes audio data included in the input sequential images. The audio-video processing module 107 processes the images and the audio data in real time.

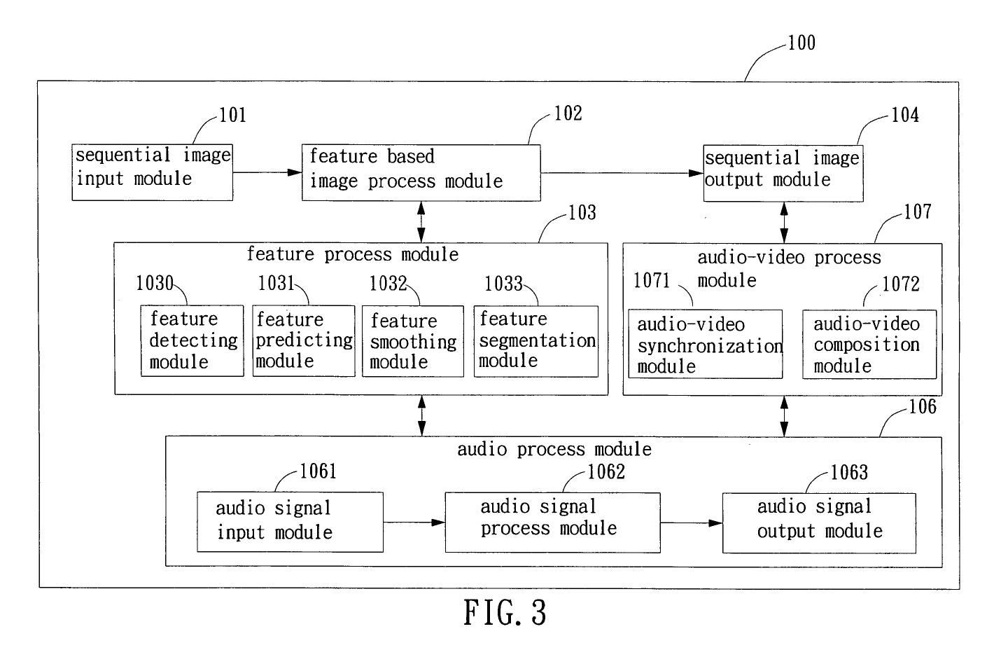

FIG. 3 is showing the details of the feature process module, the audio process module and the audio-video process module. In FIG. 3, the feature process module 103 comprises a feature detecting module 1030 for detecting the feature of the image with a feature predicting module 1031 contributing to predict the feature transition or a feature smoothing module 1032 for smoothing the feature transition or an feature segmentation module 1033 for the purpose described previously. In various embodiments, in the module 103, the module 1031, 1032 or 1033 can exist individually with module 1030 or in any combination way with module 1030 depending on requirement. The audio process module 106 comprises an audio signal input module 1061 to receive input audio data, an audio signal process module 1062 for changing the input audio data, and an audio signal output module 1063 for outputting the changed audio data. The audio-video processing module 107 comprises an audio-video synchronization module 1071 for synchronizing the output audio data and the output images, or an audio-video composition module 1072 for synthesizing the output audio data and the output images.

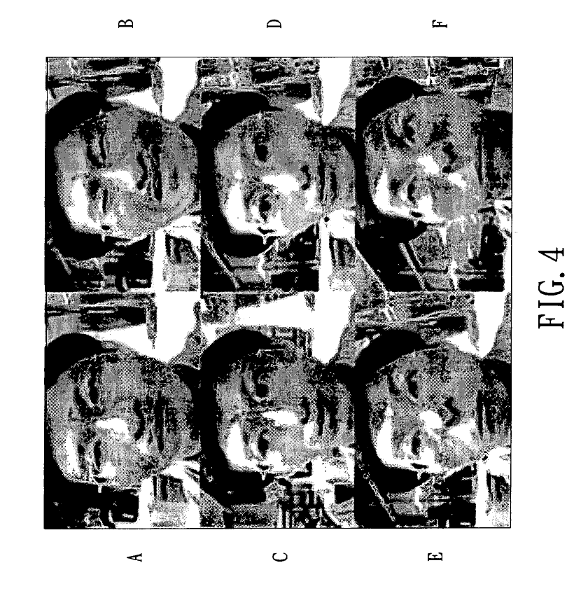

FIGS. 4A to 4F depict the operation of the described system 100. In FIG. 4A, images of a person is captured by a camera in real time and input into the system as image stream. The face of person is being changed continuously by the feature based image process module 102, and dynamic variation of the facial expression is thus created. An output image stream as result is shown in FIG. 4B to 4F respectively. The technology disclosed in the invention changes the variables of the feature based image process module 102 according to the variety of the change vector of the characteristic object trace and creates various effects corresponding to different variety.

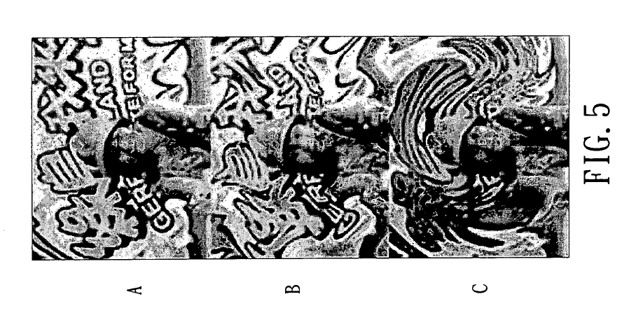

FIG. 5 shows an animation effect for a girl feeling dizzy. Real time images of a girl, which are sequential images, are input by a camera directly. Each portions of the image are changed by the feature based image process module 102 continuously according to characteristic change vectors, and a real time image stream is output as result. The effect is shown in FIGS. 5A to 5C.

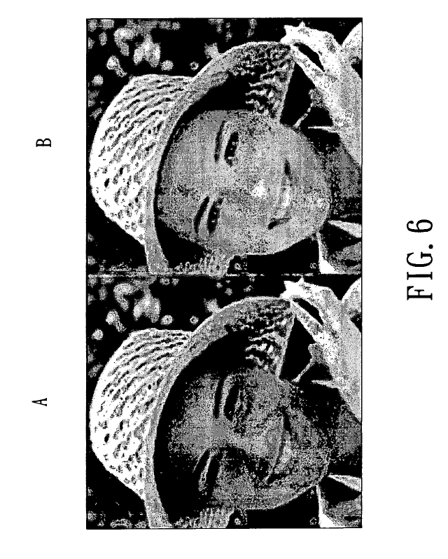

FIGS. 6A to 6B show variety of girl skin. Real time images of a girl, which are sequential images, are input by a camera directly. The skin portion of the girl image is changed by the feature based image process module 102 to create an effect of white and fine skin. A real time image stream is output when the process is accomplished. The effect is shown in FIG. 6B.

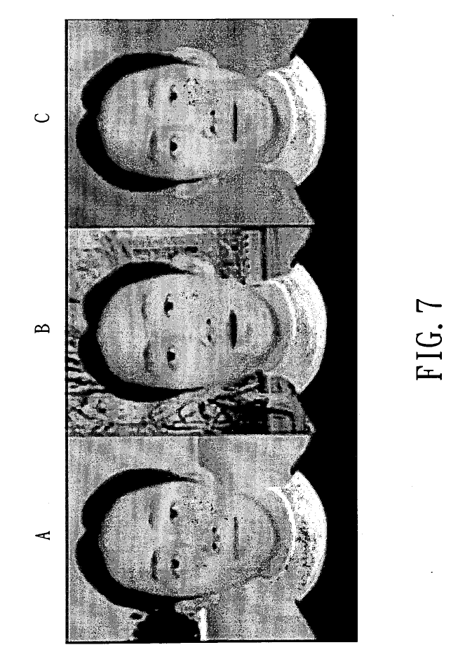

FIGS. 7A to 7C show an embodiment of changing background. Real time images of a man, which are sequential images, are input by a camera directly. The feature segmentation module 1033 divides the image into characteristic object (ex: person's image) and background object. The feature based image process module 102 processes the characteristic object and the background such as changing the facial expression, brightening or blurring the characteristic object and changing the background. A real time image stream is output when the process is accomplished. The result effect is shown in FIGS. 7B and 7C.

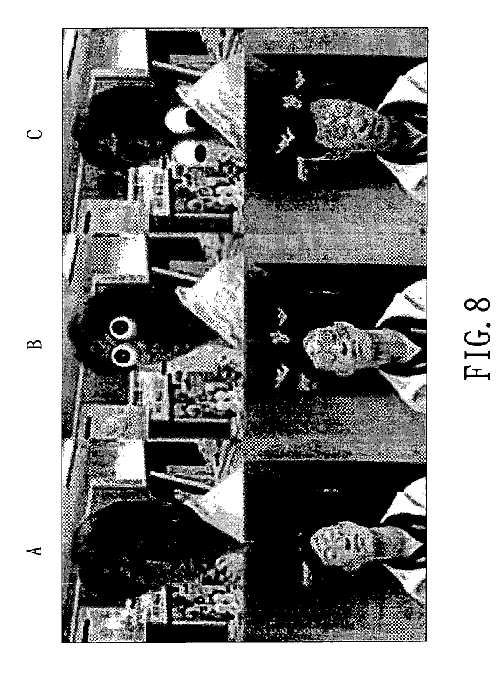

FIGS. 8A to 8C show a virtual object is synthesized by the system of the invention. Real time images of a man, which are sequential images, are input by a camera directly. A characteristic object (person image) is divided by the feature segmentation module 1033. A virtual object such as an exaggerated eyeball is added to the characteristic object via appropriate rotation, translation and scaling based on the position and motion thereof. A real time image stream is output when the process is accomplished. The effect is shown in FIGS. 8B and 8C. The technology disclosed in the invention changes the variables of the feature based image process module 102 according to the variety of the change vector of the characteristic object trace and creates various effects corresponding to different virtual objects.

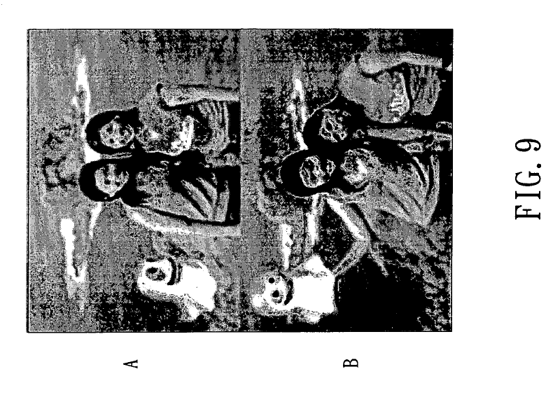

FIGS. 9A and 9B show interaction of two virtual objects. The feature segmentation module 1033 divides the image into characteristic objects and background object. The feature based image process module 102 changes the position and action of both virtual objects. The effect is added into the portion outside the characteristic object to output a real time image stream as shown in FIG. 9B.

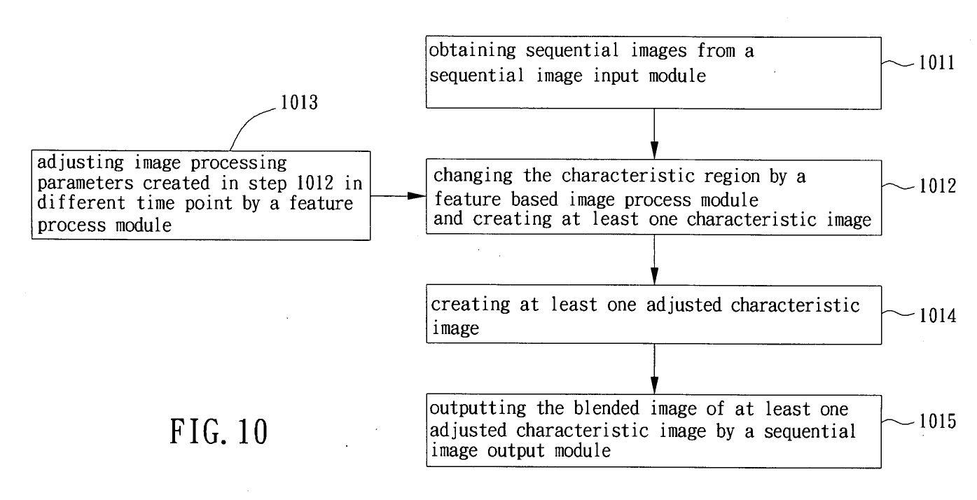

Please referring to FIG. 10, FIG. 10 is the flow chart of the method of the invention, as shown, the steps of the method comprises:

Step 1011: obtaining sequential images from a sequential image input module.

Step 1012: changing the characteristic region by a feature based image process module and creating at least one characteristic image.

Step 1013: adjusting image processing parameters created in step 1012 in different time point by a feature process module.

Step 1014: creating at least one adjusted characteristic image.

Step 1015: outputting the blended image of at least one adjusted characteristic image by a sequential image output module.

As shown above, the present invention discloses a system and a method of processing stream video. The sequential image input module inputs sequential images in real time which can be sequential image captured by a video camera or a web camera, or an available image files or a video. The feature based image process module changes the input sequential images. The feature segmentation module divides characteristic objects or characteristic regions of the input sequential images and processing the characteristic objects or regions to create animation in real time. The feature process module varies variables of the feature based image process module according to the time variable. The sequential image output module outputs sequential images. A characteristic object is selected from the image and adjusted by the described modules to create animation.

In summary, the invention has advantages to improve the shortcomings in a traditional complex image process tool and does not need a skilled professional to create animation in real time. While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for processing streaming video in real time, comprising:
a sequential image input module for inputting sequential images;
a feature based image process module for changing the input sequential images;
a feature process module for generating values of parameters of the feature based image process module according to time variable; and
a sequential image output module for outputting the varied sequential images.

2. The system for processing streaming video as claimed in claim 1 further comprising an audio process module for processing audio data.

3. The system for processing streaming video as claimed in claim 2, wherein the values of the parameters of the audio process module are generated by the feature based image process module and the feature process module.

4. The system for processing streaming video as claimed in claim 2 further comprising an audio-video processing module for processing the images and the audio data.

5. The system for processing streaming video as claimed in claim 1, wherein the feature process module comprises a feature detecting module for detecting characteristic objects or characteristic regions, a feature segmentation module for dividing characteristic objects or characteristic regions of the input sequential images, a feature predicting module for contributing to predict feature transitions, and a feature smoothing module for smoothing the feature transitions.

6. The system for processing streaming video as claimed in claim 2, wherein the audio process module comprises an audio signal input module for receiving input audio data, an audio signal process module for changing the input audio data, and an audio signal output module for outputting the changed audio data.

7. The system for processing streaming video as claimed in claim 4, wherein the audio-video processing module comprises a audio-video synchronization module for synchronizing the output audio data and the output images, or an audio-video composition module for synthesizing the output audio data and the output images.

8. The system for processing stream video as claimed in claim 1, wherein the input sequential images are video files or animation stream created by an image acquisition device or by an image generation device or application.

9. The system for processing streaming video as claimed in claim 1, wherein the output images are video files or animation stream.

10. A method of processing animation stream comprising the following steps:
(a) obtaining sequential images from a sequential image input module;
(b) generating the values of varying sequential image adjusting parameters for each time point with a feature process module;
(c) changing the sequential images by a feature based image process module;
(d) outputting the changed sequential images by a sequential images output module.

11. A method of processing animation stream comprising the following steps:
(a) obtaining sequential images from a sequential image input module;
(b) changing the characteristic region by an feature based image process module and creating at least one characteristic image;
(c) adjusting image processing parameters created in step (b) in different time point by a feature process module;
(d) creating at least one adjusted characteristic image;
(e) outputting the blended image of at least one adjusted characteristic image by a sequential image output module.

12. The method of processing animation stream as claimed in claim 10 or 11 further comprising a step of processing the characteristic objects or characteristic regions when the sequential images comprises characteristic objects or characteristic regions.

13. The method of processing animation stream as claimed in claim 12, wherein the step of processing the characteristic objects or characteristic regions further comprises the following steps:
(a) detecting features, to identify characteristic objects or regions;
(b) processing features, comprising segmenting, predicting, or smoothing characteristic objects or regions or any combination of these actions.

14. The method of processing animation stream as claimed in claim 10 or 11 further comprising a step of processing the audio data when the sequential images comprises audio data.

15. The method of processing animation stream as claimed in claim 14, wherein the step of processing the audio data further comprises the following steps:
(a) inputting audio signal;
(b) processing audio signal; and
(c) outputting audio signal.

16. The method of processing animation stream as claimed in claim 10 or 11 further comprising a step of processing the images and audio data when the sequential images comprises audio data.

17. The method of processing animation stream as claimed in claim 16, wherein the step of processing the images and the audio data comprises synchronizing the images and the audio data and synthesizing the images and the audio data to be an output work.

18. The method of processing animation stream as claimed in claim 10 or 11, wherein the input sequential images can be video files or animation stream created by an image acquisition device or by an image generation device or application.

19. The method of processing animation stream as claimed in claim 10 or 11, wherein the output images are video files or animation streams.
